(19) United States
(12) Patent Application Publication
(10) Pub. No.: US 2004/0230447 A1
(43) Pub. Date: Nov. 18, 2004

(54) Collaborative workspaces

(76) Inventors: Sven Schwerin-Wenzel, Dielheim (DE); Eric Wood, Menlo Oaks, CA (US); Nir Kol, Sunnyvale, CA (US); Dennis B. Moore, Burlingame, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/749,865

(22) Filed: Dec. 31, 2003

Related U.S. Application Data
(60) Provisional application No. 60/455,087, filed on Mar. 14, 2003.

(51) Int. Cl. G06F 17/60

(52) U.S. Cl. 705/1

(57) ABSTRACT

A method for planning a restructuring of at least two organizations includes a first interface adapted to allow a user to plan a project with a resource management capability and a time management capability, a second interface adapted to provide collaborative capabilities to restructuring members to plan the project, and one or more tools adapted to allow a user to exchange restructuring information with a person associated with one of the organizations.

### CROSS REFERENCE TO RELATED APPLICATIONS

This application claims the benefit of priority from U.S. Provisional Application entitled “ENTERPRISE CHANGE PLANNING AND EXECUTION,” filed Mar. 14, 12003, Application Serial No. 60/455,087.

### FIELD OF THE INVENTION

The present invention relates to data processing by digital system, and more particularly to collaborative workspace.

### BACKGROUND

During a merger and acquisition environment, enterprises can undergo many changes. If executed effectively, these changes can help an enterprise to achieve one or more goals. To realize those goals in a merger and acquisition environment, members associated with the enterprise changes can be involved in collaborative decisions and discussions. Consequently, an enterprise can want to carefully plan and manage communications and data access of one or more members during the merger process.

### SUMMARY

In an aspect, the invention features a method for planning a restructuring of at least two organizations, the method including a first interface adapted to allow a user to plan a project with a resource management capability and a time management capability, a second interface adapted to provide collaborative capabilities to restructuring members to plan the project, and one or more tools adapted to allow a user to exchange restructuring information with a person associated with one of the organizations.

In embodiments, the method can present an interface with a planning the period, wherein the second interface permits creating, posting, storing, and sharing information, wherein the person is selected from a class consisting of managers, employees, customers, partners, suppliers, consultants, analysts and specialists.

In another aspect, the invention features a system for implementing a merger of at least two organizations, wherein the system can include a search query interface adapted to search for terms related to one of the organizations, wherein the search query interface permits a search for a stakeholder, and a tool capable of providing communication between stakeholders of the merger.

In embodiments, the search query interface can include one or more search fields in the interface that allow a user to enter a search parameter for at least one merger organization, wherein the search parameter can include an attribute of an activity, qualification, interest, and profile of a stakeholder.

The system can include a module to store one or more search results and one or more search parameters, wherein the search query interface further can include one or more data fields of communication data, the communication data fields including at least one of a stakeholder name, a stakeholder identification number, an electronic mailing address, an office location, a building identifier, a telephone number, a room number, and a title of a merger member. The search query interface can further permit a search for a group of merger stakeholders, wherein the search query interface can include one or more data fields of communication data, the communication data fields including at least one of a group name, a group alias, a member of the group, and a group administrator.

In another aspect, the invention features a system for implementing a merger of a first organization and a second organization, wherein the system includes a first collaborative user interface for the first organization, and a second collaborative user interface for the second organization, wherein the second collaborative user interface is adapted to allow a second collaborative interface user to track a status of employee movements in the first organization.

In embodiments, at least one of the interfaces presents at least one of an organizational information, a financial statement, an organizational historical statement, a background statement, an investor information, a hierarchy of at least one of the organizations, and an answer to a frequently asked question. At least one of the interfaces can include a menu of one or more disparate interfaces for at least one of a management plan, a transition plan, a management initiative and a risk management overview.

In another aspect, the invention features a system for implementing a merger of at least two organizations, the system including a collaborative interface for one or more stakeholders, wherein the collaborative interface can include a menu adapted to allow a stakeholder to access disparate interfaces, the disparate interfaces including a communication interface, an information sessions interface, and one or more interfaces for a manager to communicate merger information with one or more employees.

In embodiments, the disparate interfaces allow interactive discussion, wherein the collaborative interface further can include at least one of a personalized merger task interface, a merger event interface, and an interface to a collaborative calendar.

In another aspect, the invention features a system including templates for a merger of at least two organizations, and graphical user interfaces adapted to display the templates, the templates including a reference model, wherein the templates are adapted for at least one of customers, employees, managers, merger partners, consultants, suppliers, and financial experts, and a module adapted to allow one or more stakeholders to communicate with a system user.

In embodiments, the system can include at least one of interactive polls, questionnaires, archived polls, and archived questionnaire responses, and a menu of various types of templates and template formats.

In another aspect, the invention features a system for implementing a merger of at least two organizations, the system including a user interface component, a dashboard, and at least one collaboration tool usable by a plurality of users, wherein the collaboration tool can include at least one of chat sessions, online meetings, interactive discussions, and synchronized browsing.

In embodiments, the system can include user interface patterns, a People Finder, and one or more Control Center Pages, wherein the user interface component is adapted to toggle between a graphical and numerical display. The system can also include a portal interacting with an enterprise management system, wherein the portal is adapted to provide a common interface to one or more program management services.

In another aspect, the invention features a system for planning a merger of at least two organizations, the system including an object modeling tool, a process modeling tool, and a user interface tool, wherein the process modeling tool enables collaborative workflow, the user interface tool including one or more collaborative interfaces for a plurality of stakeholders.

In embodiments, the system can also include a definition tool, wherein the definition tool is an integrated system tool, wherein the one or more collaborative interfaces can include a merger issue and an indicator adapted to allow a stakeholder to respond to a topic. The one or more collaborative interfaces can be adapted to allow a stakeholder to generate a procedure for exception handling for a merger action item. The one or more collaborative interfaces can include an executive cockpit, an interface adapted for chat sessions, and a personalized announcement panel.

### BRIEF DESCRIPTION OF THE DRAWINGS

FIG. 1 is a block diagram.

FIG. 2 is a flow diagram.

FIG. 3 is a block diagram.

FIG. 4 is a block diagram

FIG. 5 is an interface.

FIG. 6 is an interface.

FIG. 7 is an interface.

FIG. 8 is an interface.

FIG. 9 is an interface.

FIG. 10 is an interface.

FIG. 11 is an interface.

FIG. 12 is an interface.

FIG. 13 is an interface.

FIG. 14 is an interface.

FIG. 15 is an interface.

FIG. 16 is an interface.

FIG. 17 is an interface.

FIG. 18 is an interface.

FIG. 19 is an interface.

FIG. 20 is an interface.

FIG. 21 is an interface.

Like reference symbols in the various drawings indicate like elements.

### DETAILED DESCRIPTION

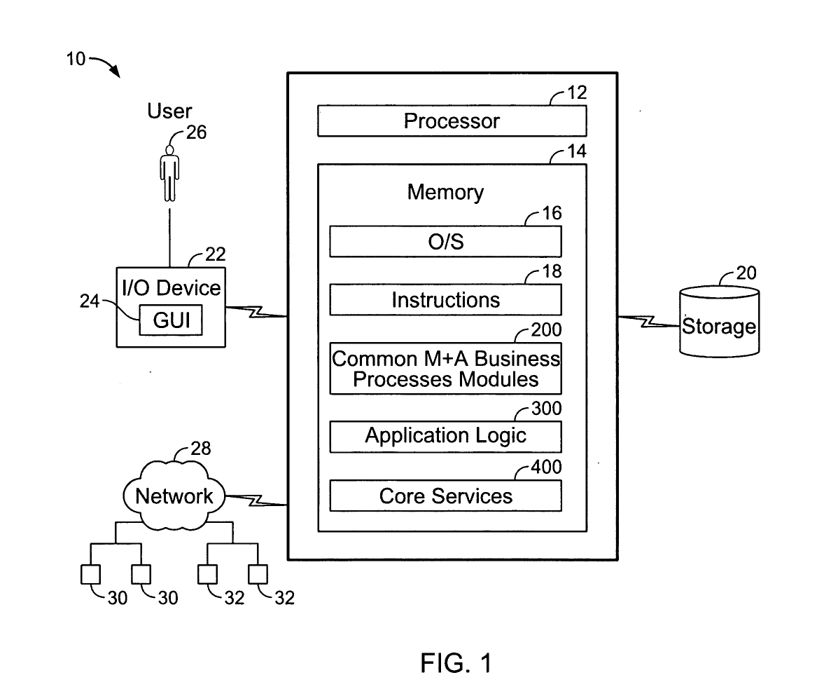

As shown in FIG. 1, a system 10 includes a processor 12 and a memory 14. Memory 14 includes an operating system 16, and instructions 18, that when executed by the processor 12, perform an exemplary restructuring integration process 100, described below. A specific restructuring process, referred to as a merger and acquisition (M&A), will be used as an example throughout this description. However, the process 100 can be applied to most corporate change or restructuring activities, such as spin-offs, department mergers and splits, and so forth. Memory 14 also includes common restructuring business processes modules 200, application logic 300, and a core framework of services 400 that support the restructuring integration process 100. The system 10 includes a link to a storage device 20 and an input/output device 22. The input/output device 22 can include a graphical user interface (GUI) 24 for display to a user 26.

The system 10 includes a link to a network 28. Network 28 links the system 10 to other systems 30 within a single entity and to systems 32 in one or more other entities. Systems 30, 32, generally referred to as clients or source systems, access data through a portal 34. Systems 10, 30, 32 are designed to act as a single logical physically distributed information system representing multiple enterprise information systems of organizations residing in the systems 30, 32. Information is exchanged between the system 10 and systems 30, 32 through the portal 34 and through user interfaces (UIs) of an architecture, described below.

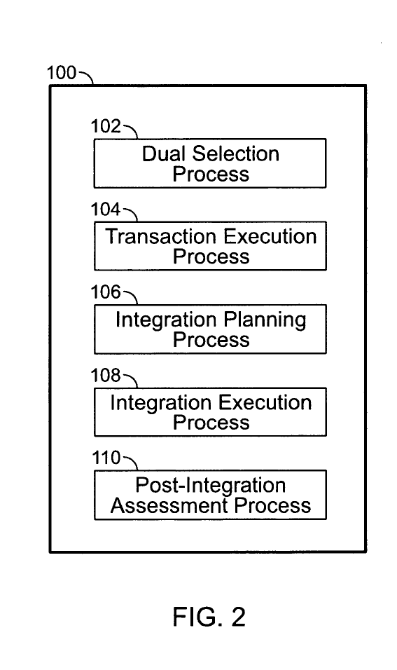

As shown in FIG. 2, the restructuring integration process 100 includes a deal selection process 102. The deal selection process 102 defines acquisition objectives and strategies. The deal selection process 102 searches for the best fit target company to meet a set of objectives and manages detailed due diligence on the target company. The deal selection process 102 also identifies synergies, risks and a realization plan for acquiring the target company.

A transaction execution process 104 structures an acquisition in terms of type, tax implications, legal issues and so forth. The transaction execution process 104 closes an acquisition deal and provides for a rollback in the event the acquisition deal fails.

An integration planning process 106 provides a plan for short term and long term tasks of acquisition integration and communicates goals and decisions to all stakeholders.

The restructuring integration process 100 includes an integration execution process 108. The integration execution process 108 manages an integration project and it sub-projects, designs a new organization, and minimizes disruptions to customers by rolling out combined field organizations quickly. The integration execution process 108 manages the integration of information technology (IT), human resources (HR), financials and procurement. The integration execution process 108 provides for the retention of key employees, manages field organization integration, and identifies cross-selling opportunities and rolls the opportunities out. The integration execution process 108 manages stakeholders, tracks an acquisition, and reports issues and successes.

The restructuring integration process 100 includes a post-integration assessment process 110. The post-integration assessment process 110 measures achieved synergies against targets, accesses where improvements can be made in synergy estimation and/or in integration execution, and applies history to a next transaction.

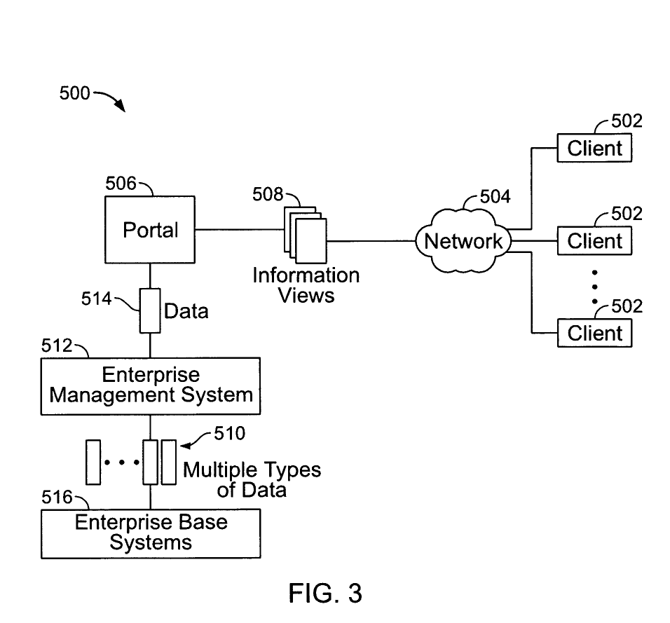

As shown in FIG. 3, the restructuring integration process 100, common restructuring business processes modules 1200, application logic 300, and core framework of services 400 are designed to conform to an architecture 1500 designed to a platform 600 that represents a single logical physically distributed information system representing multiple enterprise information systems of organizations. The architecture 1500/platform 600 insure consistency of data exchange between system 10 and source systems 30, 32, and a separation of source systems 30, 32, when appropriate during phases of the restructuring integration process 100.

The single logical physically distributed information system architecture 1500 representing multiple enterprise information systems of organizations includes multiple clients 502 accessing data over a network 504 through a portal 506. In one embodiment, the clients 502 are processes and/or web browsers that are coupled to the network 504 through a proxy server (not shown).

The portal 506 provides a common interface to program management services through user interface (UI) components 508.

The portal 506 receives requests from the clients 502 and generates information views (iViews) 1510, such as web pages, in response. In embodiments, the portal 506 implements a user roles-based system to personalize a common interface and the iViews 1510 for a user of one of the clients 502. The user can have one or more associated roles that allow personalized tailoring of a presented interface through the iViews 1510. The portal 506 communicates with an enterprise management system 512 that consolidates multiple application services. The portal 506 receives data 514 from the system 512 to fulfill the requests of the clients 502. The system 512 provides integrated application services to manage business objects and processes in a business enterprise. The business objects and processes include resources such as personnel, development projects, business programs, inventories, clients, accounts, business products, business services and so forth.

The system 512 communicates with enterprise base systems 516 to obtain multiple types of enterprise base system data 518. The base systems 516 include application services, such as human resource management systems, customer relationship management services, financial management systems, project management systems, knowledge management systems, business warehouse systems, time management systems, electronic file systems and mail systems. In embodiments, the enterprise base systems 516 include a single integration tool, such as exchange from SAP AG of Germany, which provides an additional level of integration among the enterprise base systems 516. The enterprise management system 512 consolidates and integrates data and functionality of the enterprise base systems 516 into the single management tool.

The single management tool includes systems and methods to facilitate generation of new applications within the enterprise management system 512. The new applications, generally referred to as cross-functional or composite applications, draw on resources of the enterprise base systems 516 to cross over traditional application boundaries and handle new business scenarios in a flexible and dynamic manner.

A virtual business cycle can be generated using such composite applications, where executive level business strategy can feed management level operational planning, which in turn can feed employee level execution, which can feed management level evaluation, which can feed executive level enterprise strategy. Information generated in each of these stages in an enterprise management cycle can be consolidated and presented by the enterprise management system 512 using the customized cross-functional applications. The stages provide and consume determined services that are integrated across multiple disparate platforms.

The portal 506, enterprise management system 512 and enterprise base systems 516 can reside on one or more programmable machines, which communicate over the network 504 or one or more communication busses. In embodiments, the base systems 516 reside in multiple servers connected to the network 504, and the portal 506 and enterprise management system 512 reside in a server connected to a public network (not shown). Thus, the architecture 1500 can include customized, web-based, cross-functional applications, and a user can access and manage enterprise programs and resources using these customized web-based, cross-functional applications from anywhere that access to the public network is available.

A user interface (UI) provides UI patterns used to link new objects and workflow together and generate standardized views into results generated by one or more cross-functional applications.

An object modeling tool enables generation of new business objects in a persistency/repository layer by providing a mechanism to extend a data object model dynamically according to the needs of an enterprise.

A process modeling tool enables generation of new business workflow and ad hoc collaborative workflow. The process modeling tool includes procedure templates with pre-configured work procedures that reflect best practices of achieving a work objective. A work procedure can include contributions from several individuals, generation of multiple deliverables, and milestones/phases. Whenever an instantiated business object or work procedure has a lifetime and status, a progress and status of the object or work procedure is trackable by a process owner or by involved contributors using a “dashboard” that displays highly aggregated data. The dashboard and a “myOngoingWork place” are two UI patterns that are provided by the UI components 508.

Whenever there is a concept of “myObjects,” “myRecentObjects,” “myRelatedObjects” or “myPreferredObjects,” then an object picker UI pattern, provided by the UI components 508, is included that lets users pick their favorite object directly. Whenever people are to be searched, either for choosing one individual person or for generating a collection of people meeting some criterion, a “People Finder” concept can be applied. A key aspect of searching for a person is described as an attribute within the user's activity, qualification, interest, and collaboration profile. For a given cross-functional application, people collections can be stored as personal or shared collections using the People Finder to make them available for further operations later on.

Whenever there is a strategic view on a cross-functional application scenario, analytics of the overall portfolio can be made available in the form of a collection of the UI components 508. A view selector is used to display/hide components, and a component can be toggled between graphical and numerical display and include a drop-down list or menu to select sub-categories or different views.

Cross-functional application scenarios provide related information to the user when possible, and some parts within a larger cross-functional application define what kind of related information is to be offered. Heuristics can be used to identify such relatedness, such as follows: (1) information that is related to the user due to explicit collaborative relationships such as team/project membership or community membership; (2) information that is similar to a given business object in a semantic space based on text retrieval and extraction techniques; (3) recent objects/procedures of a user; (4) other people doing the same or similar activity (using the same object or procedure template, having the same work set); (5) instances of the same object class; (6) next abstract or next detailed class; (7) explicit relationships on the organizational or project structure; (8) proximity on the time scale; (9) information about the underlying business context; and/or (10) information about the people involved in a collaborative process.

Cross-functional applications also can include generic functionality in the form of “Control Center Pages” that represent generic personal resources for each user. These cross-functional applications can refer to the following pages, where appropriate: (1) A “MyOngoingWork” page that provides instant access to all dashboards that let users track their ongoing work. Ongoing work refers to the state of business objects as well as guided procedures. (2) A “MyDay” page that lists today's time based events that are assigned or related to the user. (3) “MyMessageCenter” page that displays all pushed messages and work triggers using a universal inbox paradigm with user selected categorical filters. (4) “MyInfo” that provides access to all personal information collections (documents, business objects, contacts) including those located in shared folders of teams and communities of which the user is a member. MyInfo can also provide targeted search in collaborative information spaces such as team rooms, department home pages, project resource pages, community sites, and/or personal guru pages.

The object modeling tool, process modeling tool and user interfaces are used to build components of cross-functional applications to implement new enterprise management functions without requiring detail coding development by a system architect or programmer.

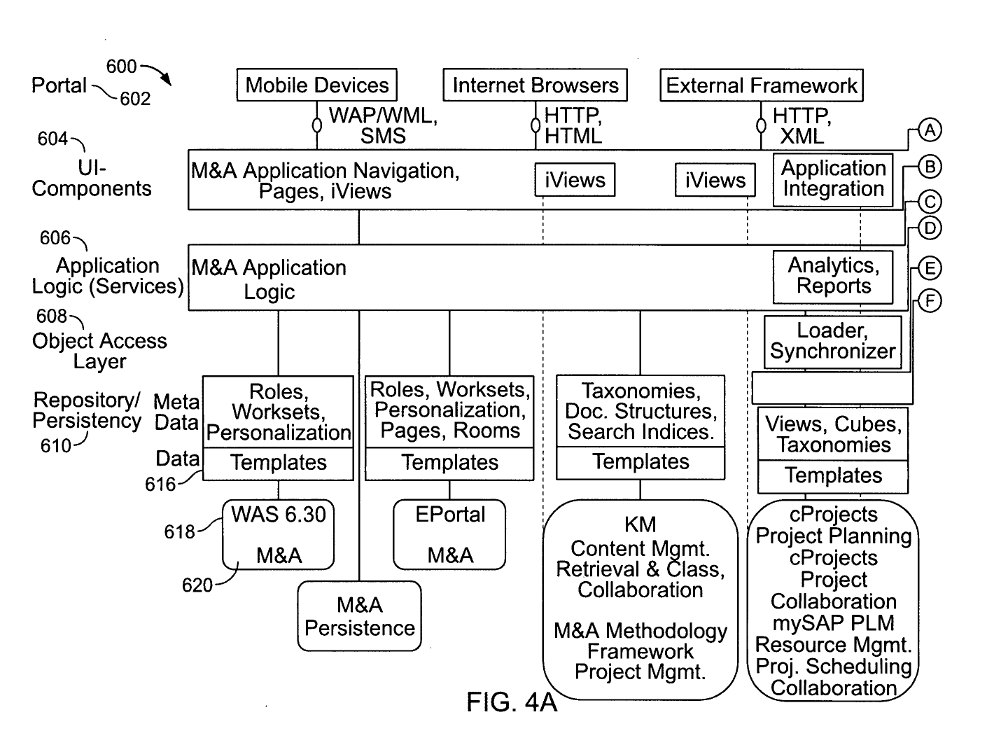

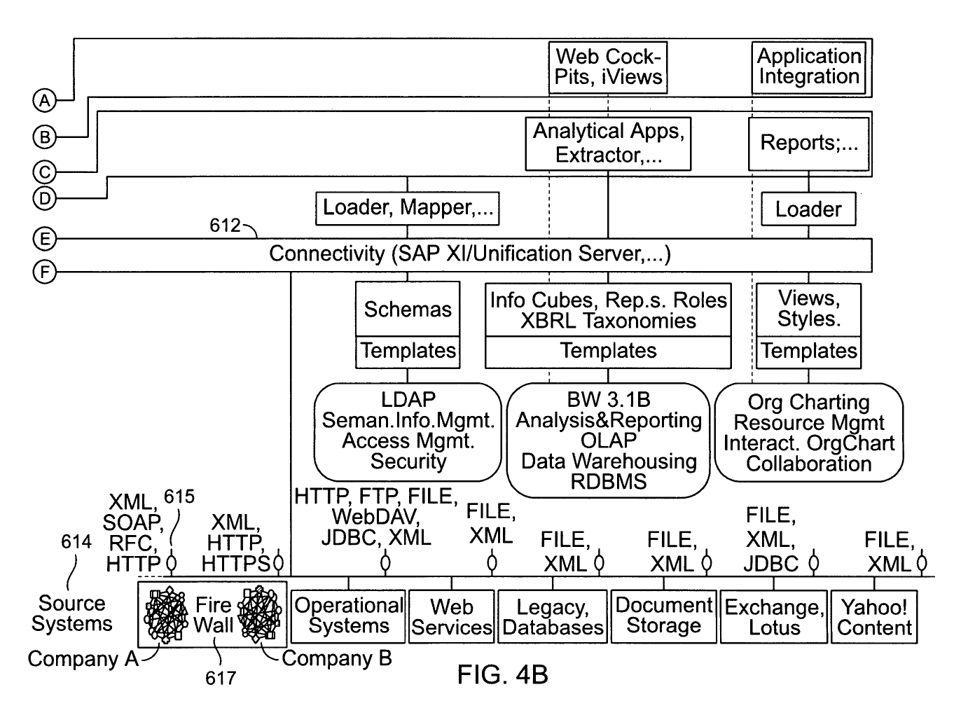

As shown in FIG. 4, a platform 600 that supports the architecture 1500 includes a portal 602, user interface (UI) components 604 and application services logic 606. The platform 600 includes an object access layer 608, a persistence/repository layer 610, connectivity layer 612, and source systems 614. In embodiments, the architecture includes software and components from SAP AG of Germany, as well as special corporate restructuring modules.

Graphical user interfaces (GUIs) provide interaction between a user and the UI components 604 through the portal 602. The UI components 604 interact with the application services logic 606. The application services logic 606 interact with databases and repositories in the persistence/repository layer 610. The user requests information via a GUI through the portal 602. The application services logic 606 processes the user request, retrieves the appropriate requested information from the databases and repositories in the persistence/repository layer 610, and sends the requested information to GUI for display to the user.

The databases and repositories in the persistence/repository layer 610 can contain metadata. Metadata refers to data that describes other data, such as data pertaining to roles, work sets and personalization information, for example. The metadata can interact with the object access layer 608, connectivity layer 612 and application services logic 606. The metadata can also interact with templates 616. The templates 616 provide a format or organization of information according to preset conditions. The templates 616 can interface with Web application server (WAS) processes 618 and core merger processes 620 in the repository layer 610.

In embodiments, the databases and repositories in the persistence/repository layer 610 interact with the source systems 614 through base system connectors 615 using a markup language such as extensible markup language (XML), web services such as SOAP, request for comments (RPC), or TCP/IP. The source systems of one organization can interact with the source systems of another organization through a firewall 617.

The base system connectors 615 can include a enterprise connector (BC) interface, Internet communication manager/Internet communications framework (ICM/ICF), an encapsulated postscript (EPS) interface and/or other interfaces that provide remote function call (RFC) capability.

The persistence/repository layer 610 provides the platform 600 with its own database and data object model. The database and data object model provides a consolidated knowledge base to support multiple enterprise functions, including functions generated as cross-applications. Active communication between the persistence/repository layer 610 and the base systems 516/614 provides a linkage between real time relational data from multiple base systems 516/614 and an integrated enterprise tool to permit strategic enterprise management and planning.

The data object model represents a subset of data objects managed by base systems 516/614. Not all of the data aspects tracked in the base systems 516/614 need to be recorded in the data object model. The data object model has defined relationships with data objects stored in the base systems 516/614. For example, certain data objects in the data object model have “read-only” or “write-only” relationships with data objects in the base systems 516/614. These types of defined relationships are enforced through a communication process between the persistence/repository layer 610 and the base systems 516/614. The persistence/repository layer 610 decouples application development from the underlying base systems 516/614.

Merger deals often involve an increasing number of teams and stakeholders. Early in a merger process, due to secrecy limitations, only a few stakeholders are involved. Later, when other stakeholders join and take over the merger process, the original teams are usually dispersed. The addition of new stakeholders can cause disconnects in the transfer and interpretation of information, and also can cause poor alignment of teams.

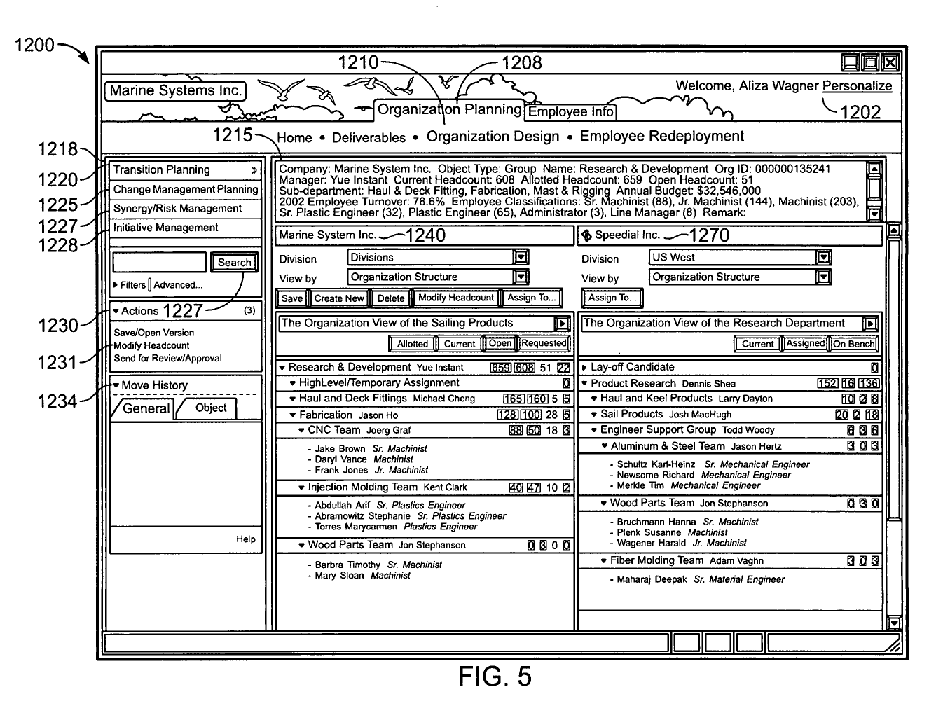

FIG. 5 illustrates an exemplary organizational design tool interface 1200. The interface 1200 can be selected by a stakeholder 1202 in the organizational planning menu 1208. The interface 1200 can include a panel 1240 for an acquiring organization, such as Marine Systems Inc., and a panel 1270 for an acquired organization, such as Speedial Inc. The organizational design interface 1200 can be used for stakeholder members involved with strategic organizational design and transition planning. Such an interface 1200 also can facilitate the management of organizational design in the post-closing period.

A “fact sheet” panel 1215 displays organizational information, such as a financial statement, an organizational historical or background statement, investor information, and answers to frequently asked questions (FAQs). The “fact sheet” panel 1215 also displays one or more details for a particular stakeholder group, employee headcount, headcount types, previous headcount transitions, and predicted headcount transitions.

Another panel 1218 in the interface 1200 permits the stakeholder 1202 to navigate among a display of various interface views, such as a transition planning view 1220, a change management planning view 1225, a synergy/risk management view 1227, and an initiative management view 1228. The stakeholder 1202 can enter a search query 1229, and perform other actions 1230 related to organizational planning 1208, such as modifying headcount 1231. Additionally, the panel 1218 can allow the stakeholder to access a history 1234 of other stakeholder and group movements during a merger.

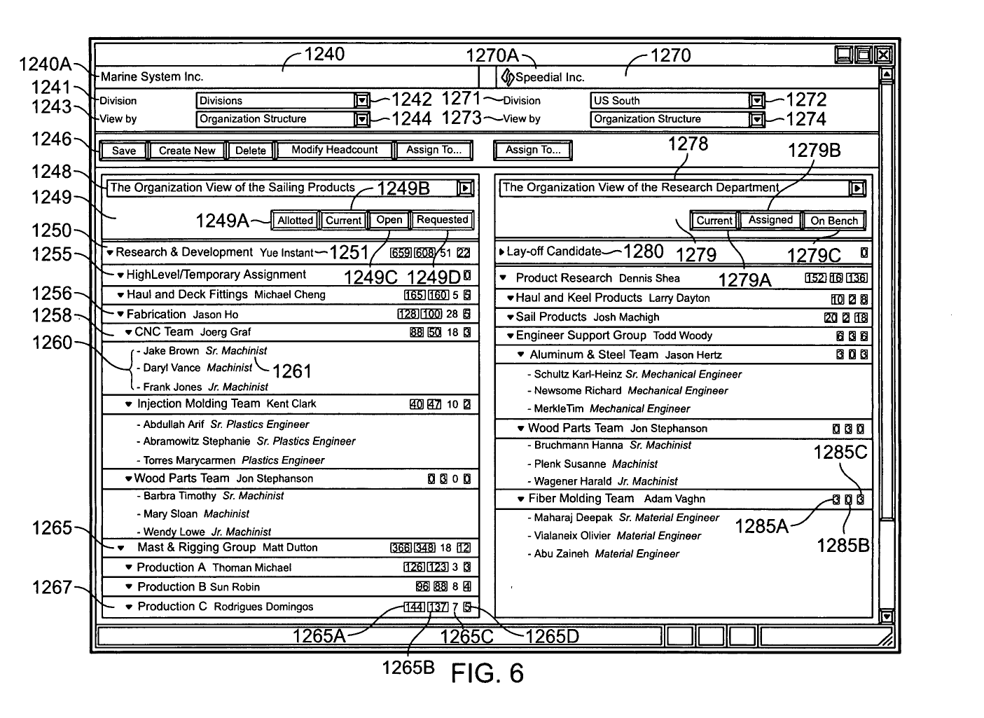

FIG. 6 presents a panel 1240 for the acquiring organization, and a panel 1270 for an acquired organization. The panels 1240 and 1270 enhance organizational design efforts when planning new headcounts, shifting headcounts, or tracking transition changes. Additionally, the panels 1240 and 1270 assist in employee reassignments by searching and matching resources, and tracking the status of employee movements. Since other organizational planning stakeholders can view and edit the interface 1200 and the panels 1240 and 1270, they support collaborative employee assignment and management of redeployments.

The panel 1240 presents a view 1248 of the acquiring organization 1240A. A stakeholder 1202 can elect a division 1241 of the organization 1240A with a selector 1242. The selector 1242 can open a pull-down menu of options such as divisions, offices, function or status. The stakeholder 1202 also can select a view 1243 with another selector 1244. The selector 1244 can open a pull-down menu of viewable options such as organizational structure, job function, and grade. Furthermore, the panel 1240 presents other options 1246 to the stakeholder 1202 including saving a profile, creating a new profile, deleting a profile, modifying organizational headcount, or making an assignment to another stakeholder of one or more organizations.

The organizational view 1248 of the Sailing Products can display a hierarchy of departments such as research and development 1250 and fabrication 1256. The panel 1240 can identify a lead stakeholder 1251 of each department, and a group 1260 of stakeholders, including an organizational title 1261 for each stakeholder group member. The status of a number 1249 of positions can also be displayed for each division, group or subgroup. For example, the Production C subgroup 1267 in the Mast and Rigging Group 1265 presents a number 1265A of allotted positions 1249A, a number 1265B of current positions 1249B, a number 1265C of open positions 1249C, and a number 1265D of requested positions 1249D. The panel 11240 also can show the status of transitional stakeholders or stakeholders with temporary assignments 1255.

Panel 1270 presents an organizational view 1278 of a research department of an acquired organization 1270A, Speedial Inc. In panel 1270, a stakeholder 1202 can elect a division 1271 of the organization 1270A with a selector 1272. However, the selector 1272 can open a different pull-down menu than the selector 1242 of panel 1240. For instance, the selector 1272 can open a pull-down menu of options displaying regional organizational divisions such as US South, US East, US West, and US Central.

As in panel 1240, panel 1270 can present information to display the status of a number of positions for each stakeholder division or group. For instance, panel 1270 shows that the Fiber Molding Team 1290 has a number 1285A of current positions 1279A, a number 1285B of assigned positions 1279B, and a number 1285C of undetermined positions 1279C. The panel 1270 can even display layoff candidates 1280.

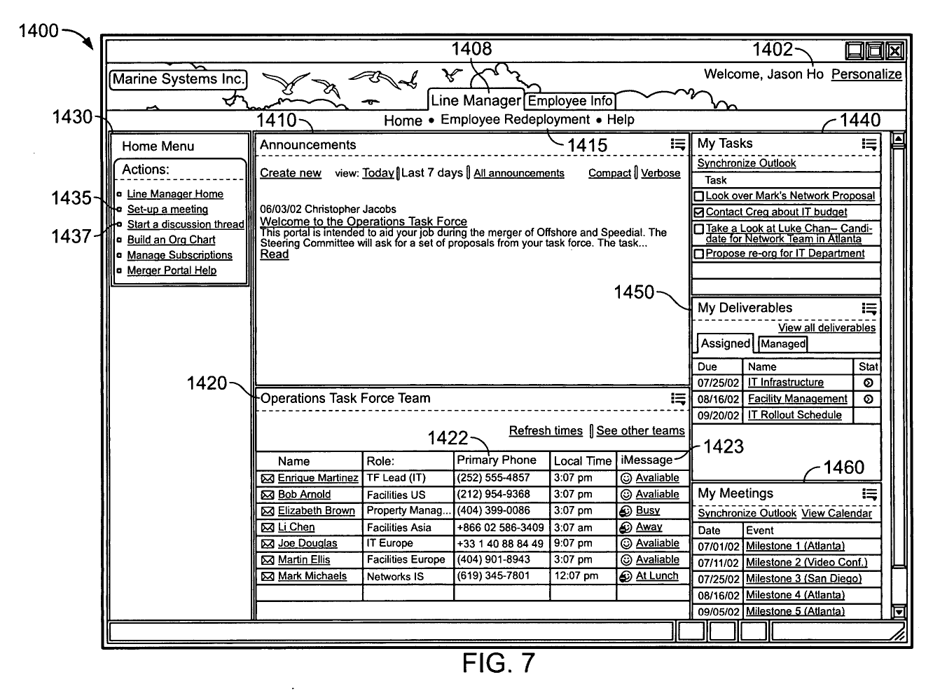

FIG. 7 illustrates an exemplary tool interface 1400 for a stakeholder 1402 (e.g., a line manager). The interface 1400 can be personalized 1402 for the stakeholder 1402 and greet the stakeholder 1402 with an announcement panel 1410. The stakeholder 1402 can view a panel 1420 of the operations task force team, along with the contact information 1422 and availability 1423 of team members.

The interface 1400 allows the stakeholder 1402 to collaborate with other stakeholders to conduct organizational design tasks such as arranging a meeting 1435 or starting a discussion thread 1437 with panel 1430. The interface 1400 can have personalized panels for tasks 1440, deliverables 1450, and meetings 1460. Each panel 1440, 1450, 1460 can have selectable hypertext link functions.

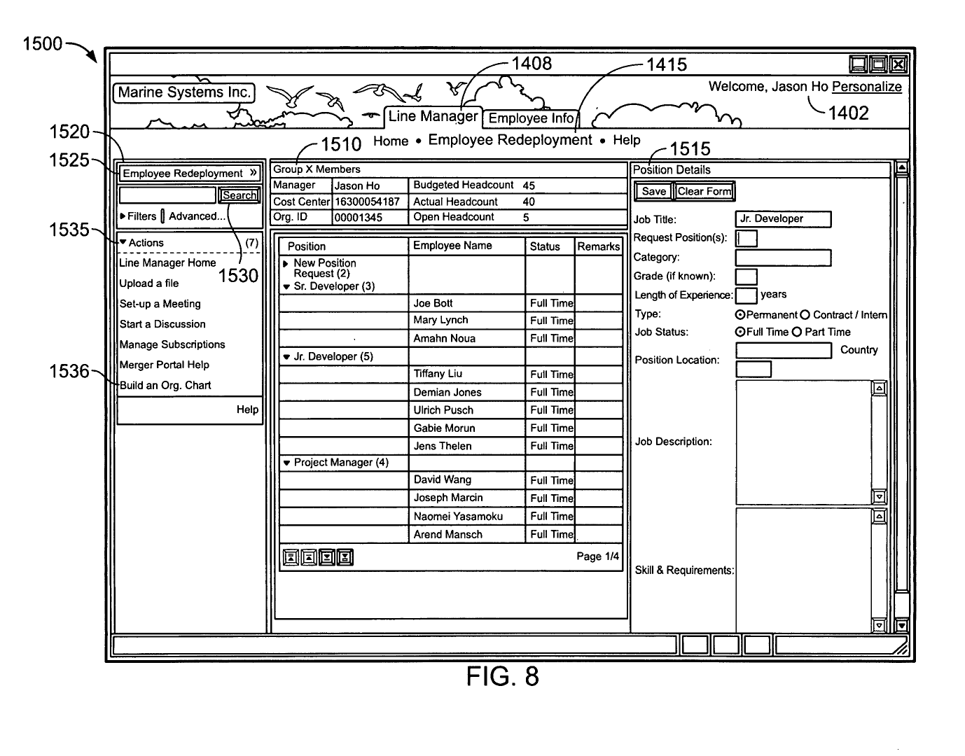

FIG. 8 illustrates an employee redeployment interface 1500 for the stakeholder 1402. For this interface 1500, an employee redeployment indicator 1415 is selected. The interface 1500 shows a panel 1510 for a group of stakeholders, a panel 1515 for positional details, and a panel 1520 with other navigational abilities for the stakeholder 1402. In panel 1520, the stakeholder 1402 can access an employee redeployment navigation indicator 1525, a search query interface 1530, and other stakeholder actions 1535, such as building an organizational chart.

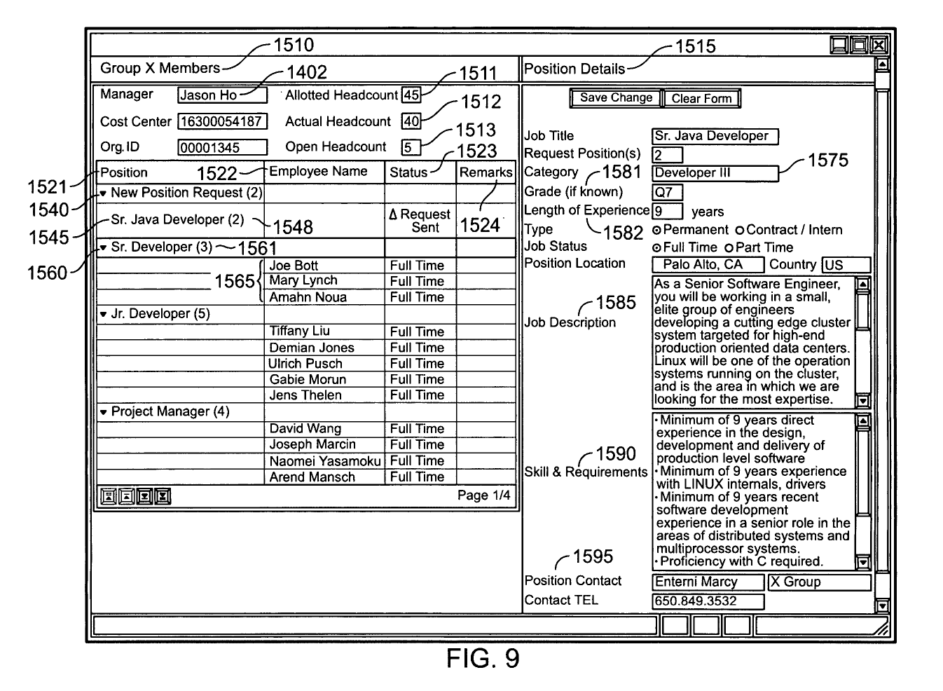

FIG. 9 presents panel 1510 and panel 1515 from interface 1500, in which panel 1515 has completed information fields, such as field 1575. In panel 1510, the stakeholder 402 can examine an allotted headcount value 1511, an actual headcount value 1512, and a value 1513 of open headcounts. The stakeholder 1402 can inspect a status 1523 for organizational positions 1521 with accompanying descriptions and remarks 1524. The stakeholder also can access the positions in an organization by the title 1560 of the position, and view a number 1561 of stakeholders 1565 listed under a particular position.

Panel 1510 also can present new position requests 1540, and the types 1545 and numbers 1548 of the new position requests 1540. A position request type 1545 is detailed in panel 1515 with completed fields, such as a job description 1585, and skills and requirements 1590. A positional grade level 1581 and length of experience 1582 also can be displayed in panel 1515. The position detail panel 1515 also can associate a position with a contact stakeholder 1595.

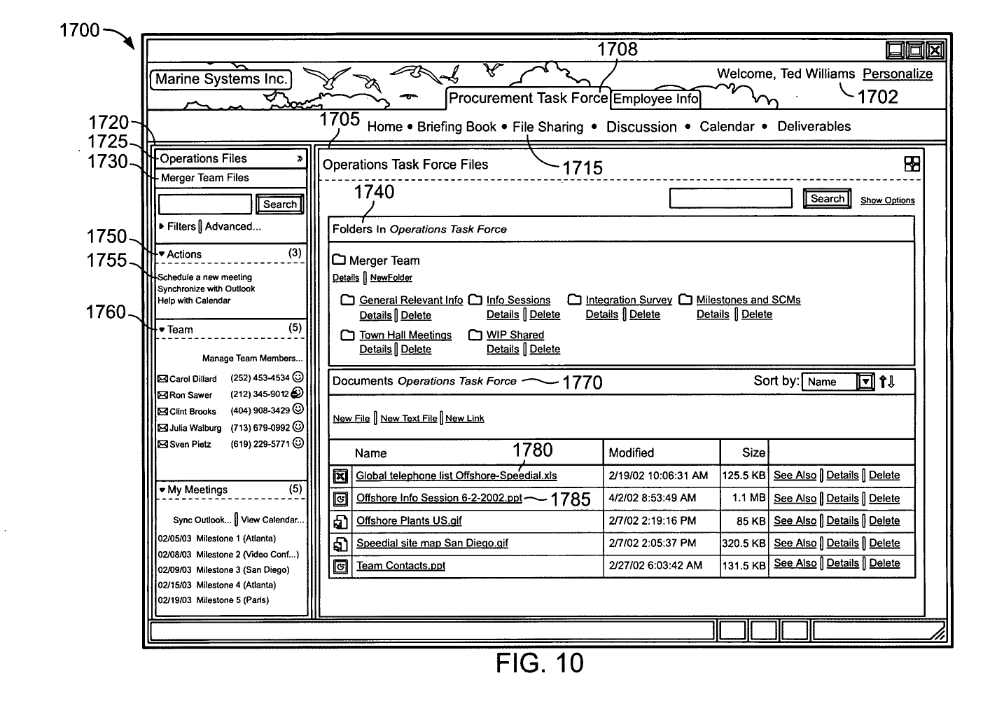

FIG. 10 illustrates an interface 1700 that allows stakeholders from various groups to collaborate and share information during the merger. In particular, the interface 1700 for a stakeholder 1702 in the procurement task force. The procurement task force tab 1708 presents the stakeholder 1702 with a menu of views, including a view 1715 for sharing objects with other stakeholders in the procurement task force. The view 1715 presents a panel 1735 for the stakeholders in the procurement task force to share folders 1740 and documents 1770 with stakeholders in the operations task force.

Examples of externally-generated objects can include an Excel spreadsheet 1780, or a PowerPoint presentation 1785. The external objects 1780 and 1785 can be generated by software made from Microsoft Corporation.

The stakeholder 1702 in the procurement task force also can share objects with stakeholders in a merger team 1730. Additionally, the stakeholder 1702 can view and access other procurement task force team members 1760 and initiate merger actions 1750, such as scheduling a new meeting 1755.

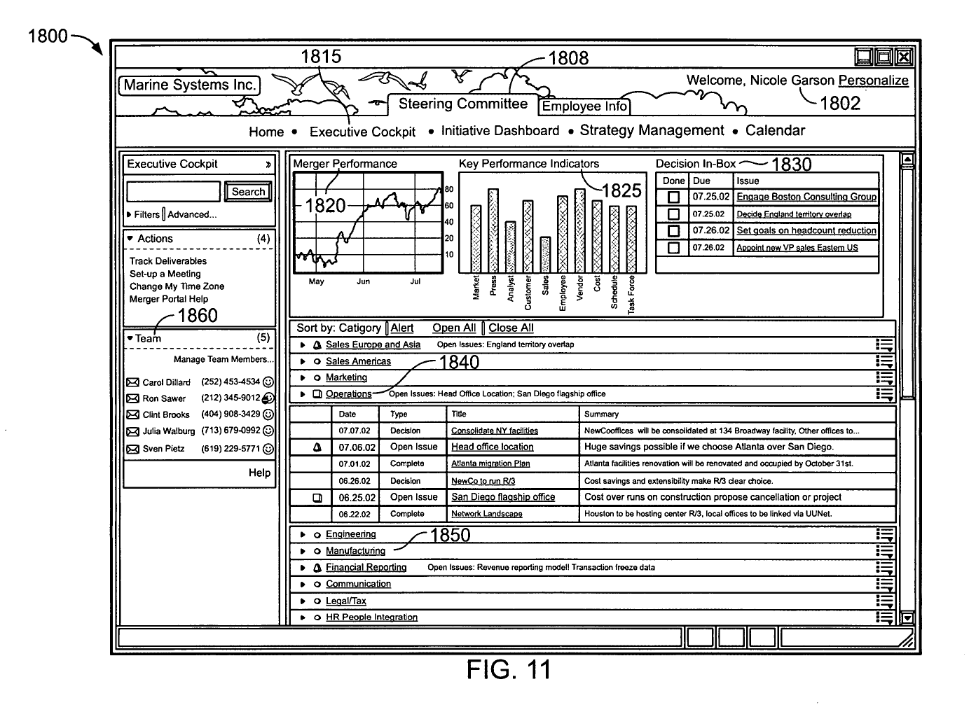

FIG. 11 illustrates a tool interface 1800 for a stakeholder 1802 in a merger steering committee. The steering committee can have an interface tab 1808 that presents a menu of views, including the presented view of an “executive cockpit” 11815. The executive cockpit can also be referred to as a “Control Center” page or dashboard. The executive cockpit view 1815 can allow executive board stakeholders 1145 to access, plan, and manage various aspects of the merger. The exemplary interface 1800 can chart the merger performance 1820 and present key performance indicators 1825. The interface 1800 can present merger issues in a decision box 1830. Merger issues can also be presented by type or category. For example, the stakeholder 1802 can view issues in a manufacturing division 1850 or in an operations department 1840. The interface 1800 also can allow the stakeholder 1802 to contact and manage other stakeholders 1860.

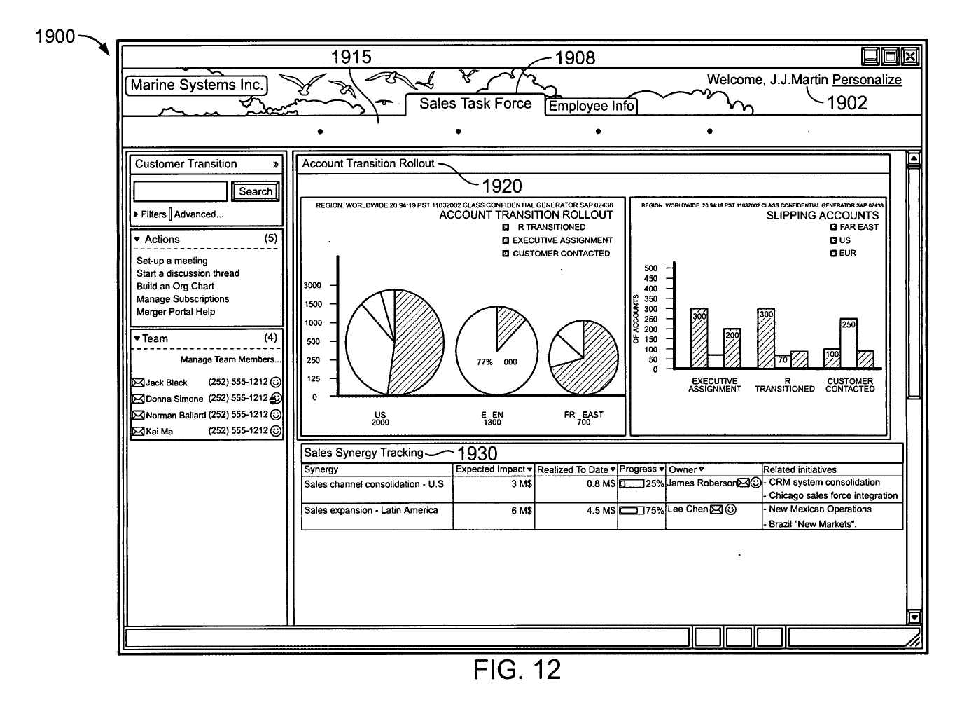

FIG. 12 shows an example of a tool interface 1900 for a stakeholder 1902 with access to a sales task force menu 1908. Other possible views for stakeholders in the sales task force interface 1900 include views for sales integration, file sharing, discussions, deliverables, and a calendar. The view presented in interface 1900 is a transition cockpit view 1915. The view 1915 allows the stakeholder 1902 to access and manage sales-related transition tools for the merger, including an account transition rollout 1920, and sales synergy tracking 1930.

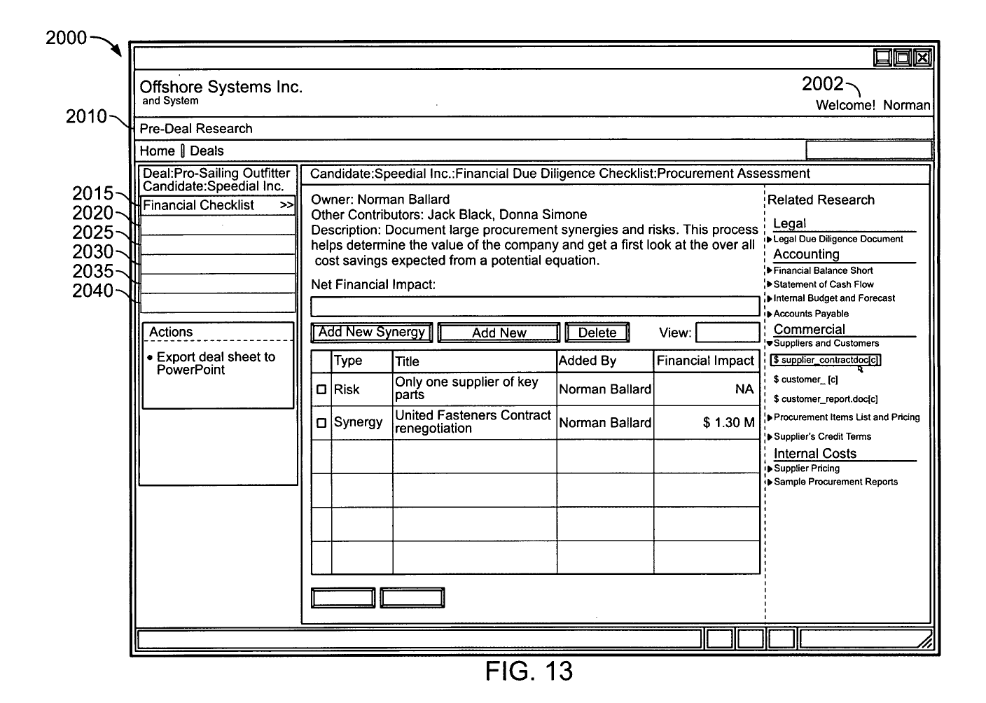

FIG. 13 shows a tool interface 2000 to allow a stakeholder 2002 to access, plan, and manage pre-deal research 2010. The stakeholder 2002 can access views in a financial checklist 2015, an operations checklist 2020, a profile of a targeted merger candidate 2025, and other research and reports 2030. The stakeholder 2002 also can schedule a meeting 2035 and view organizational synergies and risk summaries 2040.

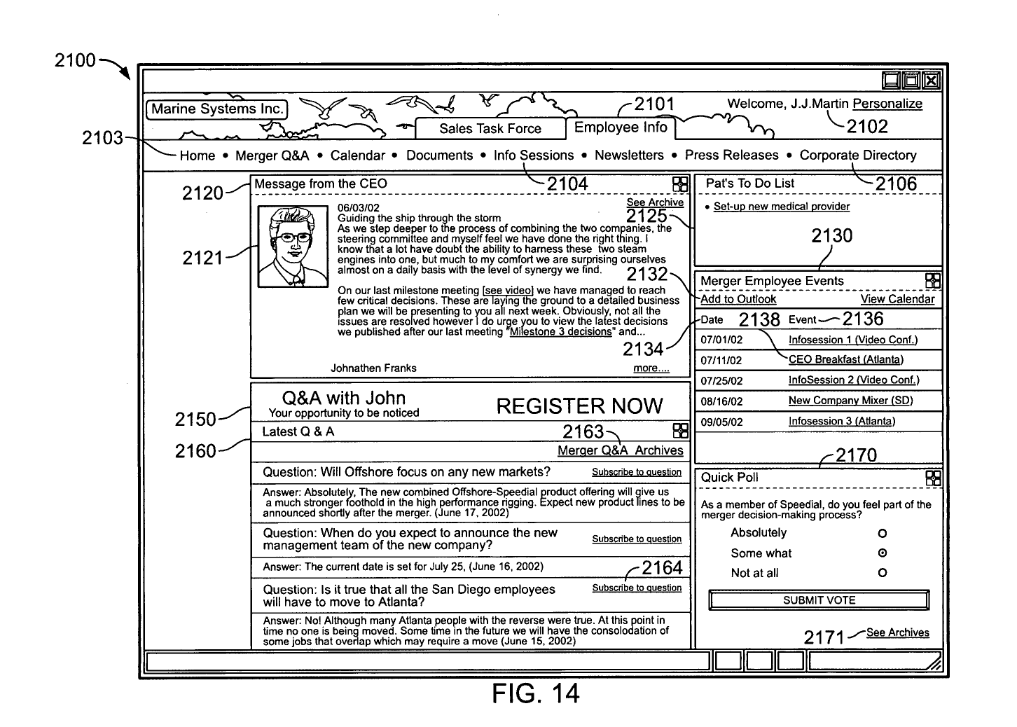

FIG. 14 illustrates an employee information interface 1400. An executive stakeholder of an organization, such as a chief executive officer (CEO) 2121, can update employee stakeholders on the progress of the merger, as illustrated in panel 2120. The employee stakeholder 2102 can also interact with the CEO 2121 with panels 2150 and 2160. Panel 2160 presents a question and answer (Q&A) session that allows employee stakeholders to submit questions or statements to the CEO 2121. The CEO 2121 can communicate with the employee stakeholder 2102, and other employee stakeholders can view the communications and join the interactive discussion 2164. Such interaction allows a merger organization to retain employee stakeholders, and reduces the amount of misinformation that can arise during a merger. Panel 2125 allows the stakeholder 2102 to have a personalized merger task list. Panel 2170 allows employee stakeholders to submit and view interactive polls or questionnaires. Employee stakeholders also can view previous polls 2171 and Q&A sessions 2163 that have been archived.

Panel 2130 can keep employee stakeholders informed of merger-related events. For example, panel 2130 displays the date 2134 and type of event 2136 related to a merger, such as a CEO breakfast event 2138 in Atlanta. The employee stakeholder 2102 can select the event link of 2138 and can be further presented with a page (not shown) of information related to the breakfast. The employee stakeholder also can add the event to an external calendar program, such as the calendar program in Outlook made by Microsoft Corporation. The employee stakeholder 2102 can also access a menu of other merger interfaces, such as a corporate directory 2106, an informational session 2104, or a personalized home page 2103.

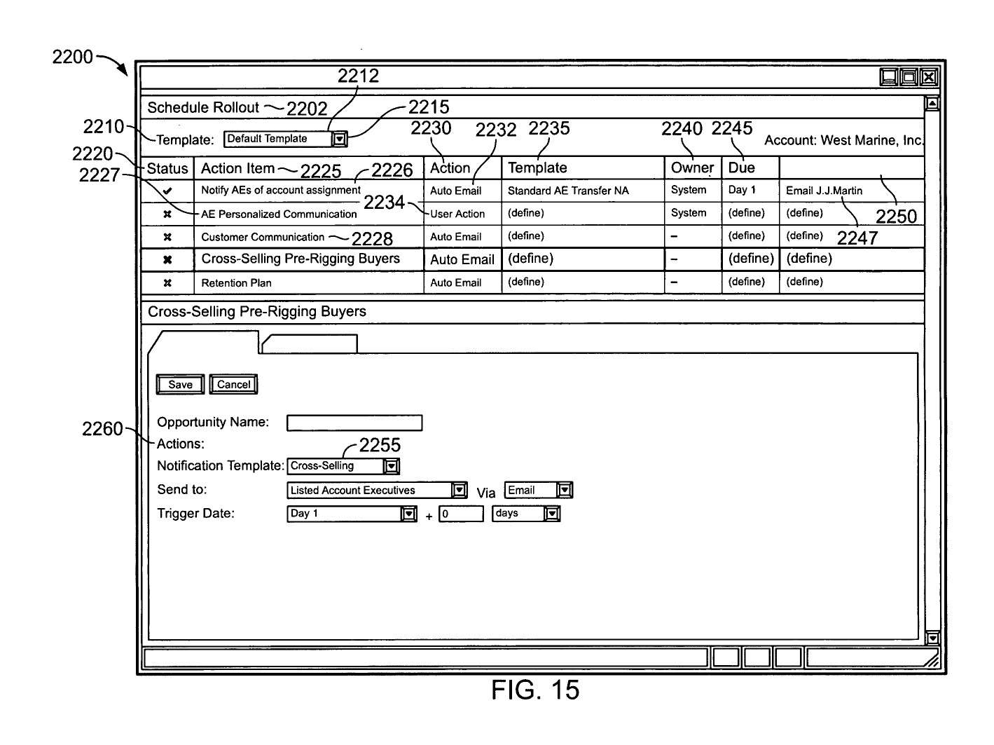

FIG. 15 illustrates a template interface 2200. The template interface 2200 can be for a specified merger topic 2202. The template interface 2200 can have a field 2210 with a selector 2215 to pull down a menu of various types of templates and template formats. For the default template 2212, the interface 2200 displays the status 2220 of a merger action item 2225. The merger action item 2225 can have an action 2230, a template format 2235, an owner 2240, an exception handling 2250, and a defined time period 2245. The merger action item 2230 can have a user-defined action 2234 or an action 2232 that is automatically generated. Additionally, the merger action item 2230 can have a procedure 2247 for exception handling 2250. The action items 2226, 2227, and 2228 can be collaborative action items for internal and/or external stakeholders. The template interface 2200 can present other actions 2260 for other collaborative templates 2255.

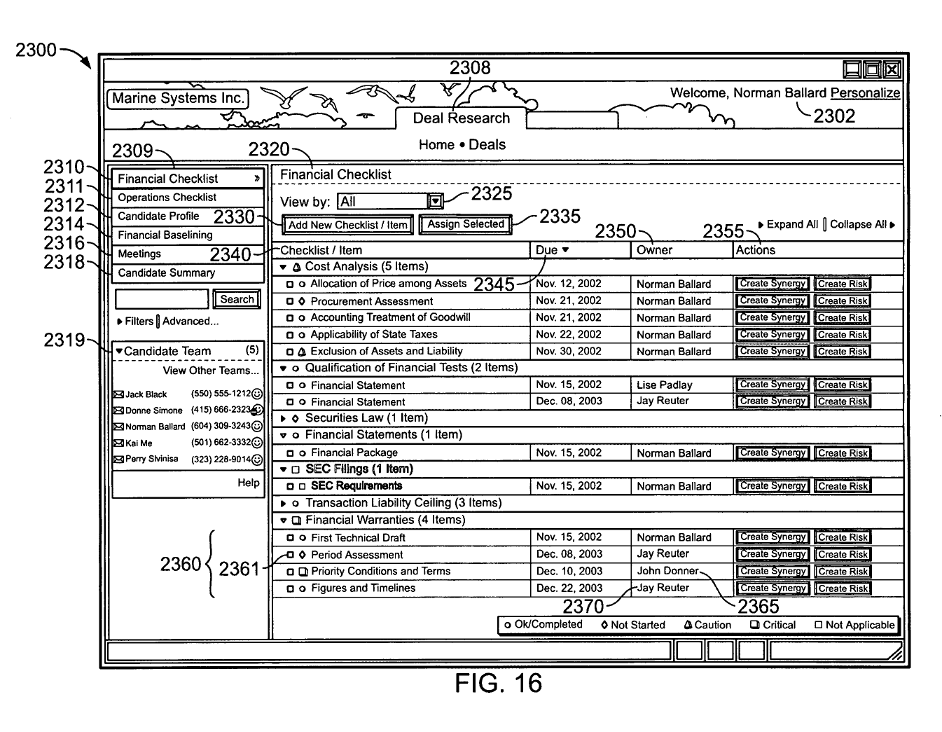

FIG. 16 presents an interface 2300 for a financial checklist panel 2320. In this panel 2320, a user 2302 can access one or more checklists 2340 of merger items.

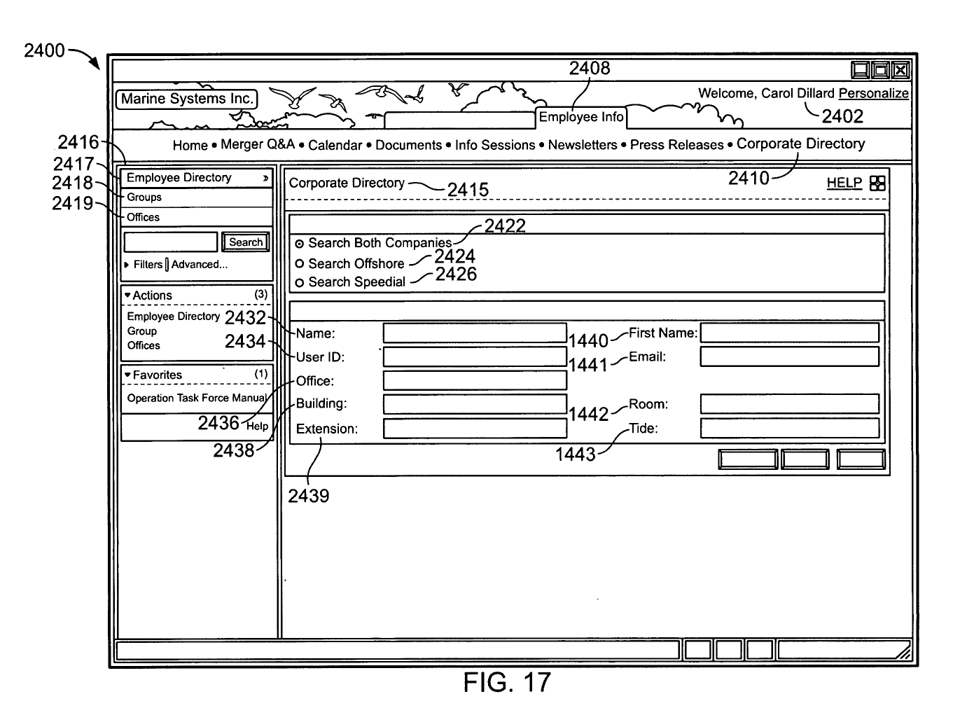

As shown in FIG. 17, stakeholders 2319 conducting deal research 2308 for the merger can collaborate on checklist items and financial objectives. The checklists 2340 can have items with deadlines 2345, owners 2350, and related actions 2355. The checklists 2340 can have a sub-checklist 1360 with items of different owners 2365 and 2370. The user 2302 can add a new checklist or a new checklist item 2330 and assign a checklist item to a new owner 2350 with button 2335. Moreover, the user 2302 can use an indicator 2361 to notify other stakeholders when the item has been completed or when the item is not longer relevant to the merger.

The interface 2300 in FIG. 16 also can have a panel 2309 that allows the user 2302 to switch views in the interface 2300. In addition to accessing the financial checklist view 2320, stakeholders 2319 can access some other views, such as an operations checklist 2311, a candidate profile 2312, financial baselining 2314, meetings 2316, and a candidate summary 2318.

FIG. 17 illustrates an interface 2400 in which a user 2402 can search for merger members in a corporate directory panel 2410. The user 2402 can select search criteria 2420 to find personnel. The search criteria 2420 can be from one of the merger organizations 2424 and 2426, or the search criteria 2420 could apply to all of the involved merger organizations 2422. The user also can search by one or more fields of communication data 2430, such as a name 2432 and 2440, an identification number 2434, an email address 2441, and office location 2436, a building name or number 2438, a telephone number 2439, a room number 2442, or a title 2443 of a merger member. The user 2402 can use another panel 2416 in the interface 2400 to access views that allow the user to search an employee directory 2417, merger groups 2418, and merger offices 2419.

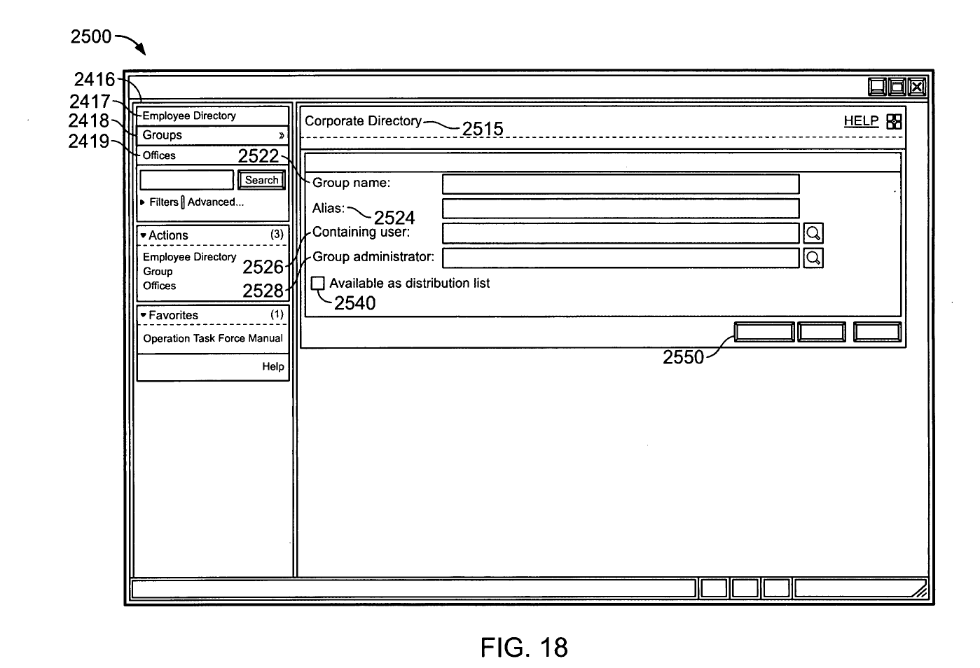

FIG. 18 illustrates an interface 2500 with a panel 2515 for a directory search in which the user 2402 can conduct group searches 2418. The panel 2515 can present one or more search criteria fields, such as a group name 2522 or a group alias 2524. The panel 2515 can even identify groups by searching for a member 2526 within a group or a group administrator 2528. The user's search can be stored as personal or shared information 2540 to allow one or more search results and parameters available for future search operations.

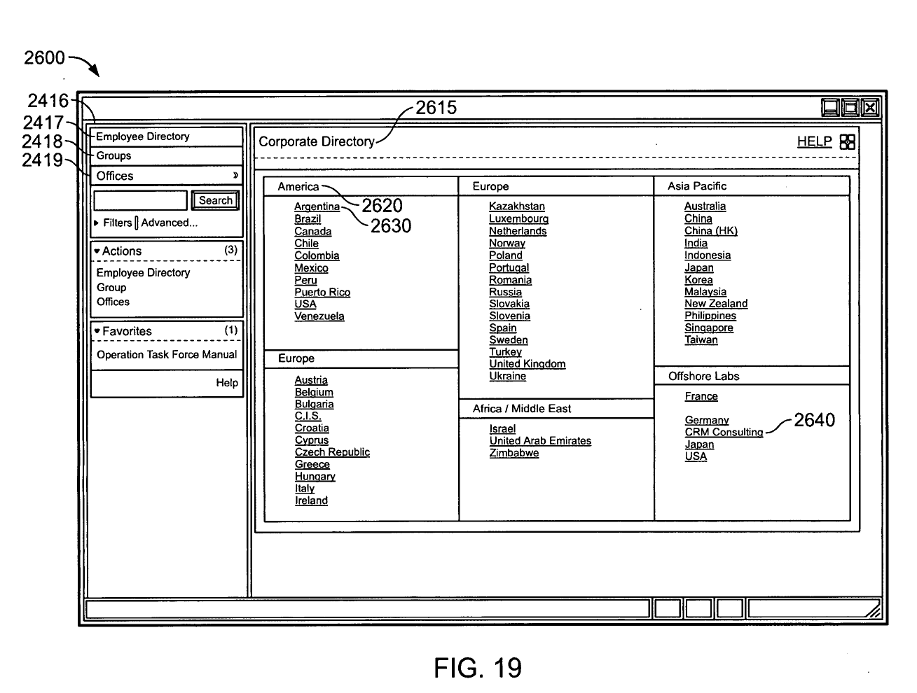

FIG. 19 presents an exemplary interface 2600 with a panel 2615 for a directory search in which the user 2402 can conduct searches by organizational offices 2419. The panel 2615 can present a regional directory 2620 with national information 2630. The panel 2615 also can include an office directory (not shown) with city and town information, as well as street addresses. Additionally, other merger-related organizations 2640 can be shown in the directory panel 2615.

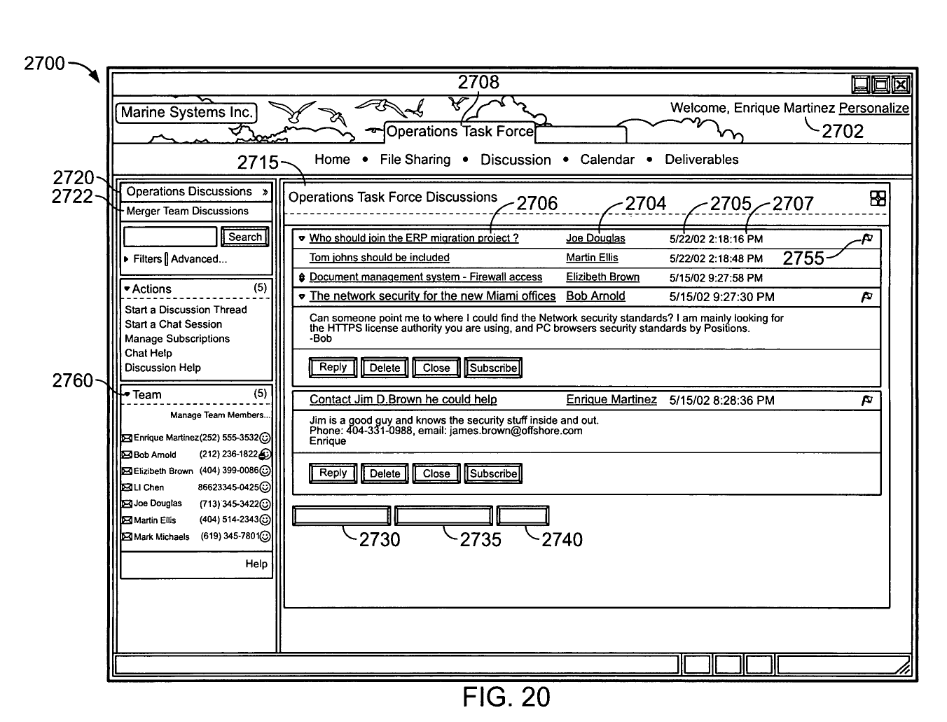

FIG. 20 illustrates an exemplary interface 2700 with a panel 2715 for group discussions. The interface user 2702 can access a merger issue 2706 posted by a member 2704 of a team 2760. The interface 2700 can show the time 2707 and date 2705 of the posting of the issue 2706. An indicator 2755 can signify that the issue 2706 should be resolved quickly. The indicator 2755 can be an indicator to respond or follow up on a topic or question. The team member 2702 can begin a new discussion 2730, subscribe to a discussion 2735, or delete a discussion 2740 from the panel 2715.

The interface 2700 also can provide collaborative discussions between members of different merger groups. For example, the user interface 2700 can be accessed by members from a merger team 2722, in addition to members of the operations task force 2720.

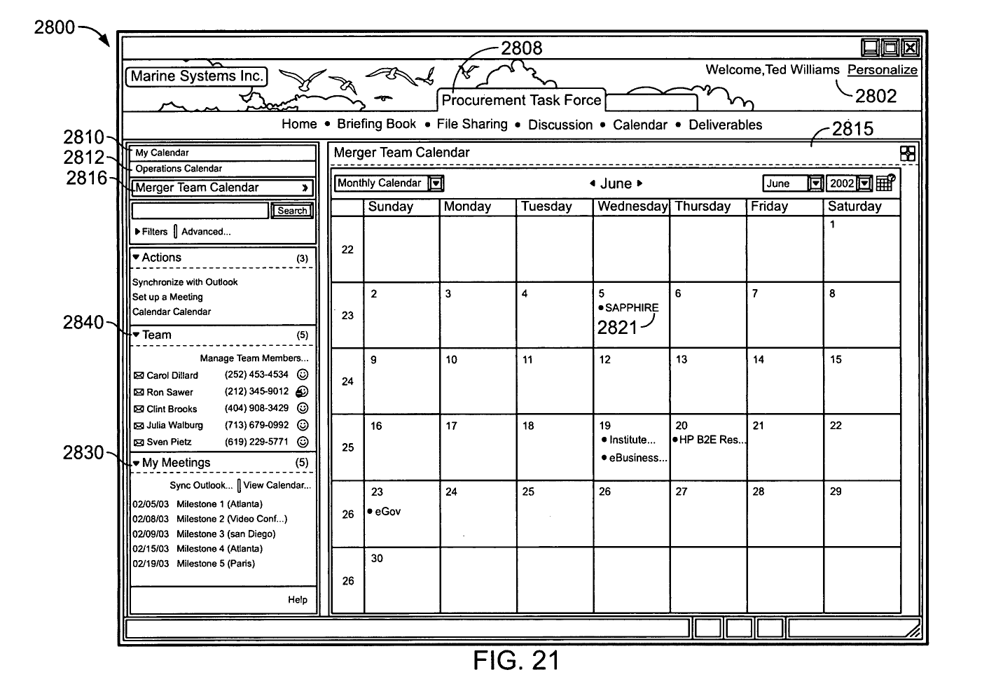

FIG. 21 shows an example of a collaborative calendar interface 2800 for a group 2840 in the merger. The collaborative calendar interface 2800 can have an event 2821 that can be scheduled by a user 2802 or a member of a group 2840. The user can also collaborate with a calendar 2812 of another merger group. The user 2802 can access a personal calendar 2810 to incorporate all of the events from each calendar in which the user 2802 can have access. The personal calendar (not shown) also can store and present personal user events and meetings 2830.

Other embodiments can be within the scope of the following claims.

What is claimed is:

1. A method for planning a merger of at least two organizations, the method comprising:
a first interface adapted to allow a user to plan a project with a resource management capability and a time management capability;
a second interface adapted to provide collaborative capabilities to a plurality of merger members to plan the project; and
one or more tools adapted to allow a user to exchange merger information with a person associated with one of the organizations.

2. The method of claim 1, wherein the method presents an interface with a planning the period, wherein the second interface permits creating, posting, storing, and sharing information, wherein the person is selected from a class consisting of managers, employees, customers, partners, suppliers, consultants, analysts and specialists.

3. A system for implementing a merger of at least two organizations, wherein the system comprises:
a search query interface adapted to search for terms related to one of the organizations, wherein the search query interface permits a search for a stakeholder; and
a tool capable of providing communication between a plurality of stakeholders of the merger.

4. The system of claim 3, wherein the search query interface comprises one or more search fields in the interface that allow a user to enter a search parameter for at least one merger organization, wherein the search parameter comprises an attribute of an activity, qualification, interest, and profile of a stakeholder.

5. The system of claim 4, further comprising a module to store one or more search results and one or more search parameters, wherein the search query interface further comprises one or more data fields of communication data, the communication data fields comprising at least one of a stakeholder name, a stakeholder identification number, an electronic mailing address, an office location, a building identifier, a telephone number, a room number, and a title of a merger member.

6. The system of claim 4, wherein the search query interface further permits a search for a group of merger stakeholders, wherein the search query interface comprises one or more data fields of communication data, the communication data fields comprising at least one of a group name, a group alias, a member of the group, and a group administrator.

7. A system for implementing a merger of a first organization and a second organization, wherein the system comprises:
a first collaborative user interface for the first organization; and
a second collaborative user interface for the second organization, wherein the second collaborative user interface is adapted to allow a second collaborative interface user to track a status of employee movements in the first organization.

8. The system of claim 7, wherein at least one of the interfaces present at least one of an organizational information, a financial statement, an organizational historical statement, a background statement, an investor information, a hierarchy of at least one of the organizations, and an answer to a frequently asked question.

9. The system of claim 7, wherein at least one of the interfaces comprise a menu of one or more disparate interfaces for at least one of a management plan, a transition plan, a management initiative and a risk management overview.

10. A system for implementing a merger of at least two organizations, the system comprising a collaborative interface for one or more stakeholders, wherein the collaborative interface comprises a menu adapted to allow a stakeholder to access disparate interfaces, the disparate interfaces comprising a communication interface, an information sessions interface, and one or more interfaces for a manager to communicate merger information with one or more employees.

11. The system of claim 10, wherein the disparate interfaces allow interactive discussion, wherein the collaborative interface further comprises at least one of a personalized merger task interface, a merger event interface, and an interface to a collaborative calendar.

12. A system comprising:
a plurality of templates for a merger of at least two organizations; and
a plurality of graphical user interfaces adapted to display the templates, the templates comprising a reference model, wherein the templates are adapted for at least one of customers, employees, managers, merger partners, consultants, suppliers, and financial experts; and
a module adapted to allow one or more stakeholders to communicate with a system user.

13. The system of claim 12, further comprising:
at least one of interactive polls, questionnaires, archived polls, and archived questionnaire responses, and
a menu of various types of templates and template formats.

14. A system for implementing a merger of at least two organizations, the system comprising a user interface component, a dashboard, and at least one collaboration tool usable by a plurality of users, wherein the collaboration tool comprises at least one of chat sessions, online meetings, interactive discussions, and synchronized browsing.

15. The system of claim 14, further comprising user interface patterns, a People Finder, and one or more Control Center Pages, wherein the user interface component is adapted to toggle between a graphical and numerical display.

16. The system of claim 15, further comprising a portal interacting with an enterprise management system, wherein the portal is adapted to provide a common interface to one or more program management services.

17. A system for planning a merger of at least two organizations, the system comprising an object modeling tool, a process modeling tool, and a user interface tool, wherein the process modeling tool enables collaborative workflow, the user interface tool comprising one or more collaborative interfaces for a plurality of stakeholders.

18. The system of claim 17, further comprising a definition tool, wherein the definition tool is an integrated system tool, wherein the one or more collaborative interfaces comprise a merger issue and an indicator adapted to allow a stakeholder to respond to a topic.

19. The system of claim 17, wherein the one or more collaborative interfaces are adapted to allow a stakeholder to generate a procedure for exception handling for a merger action item.

20. The system of claim 17, wherein the one or more collaborative interfaces comprise an executive cockpit, an interface adapted for chat sessions, and a personalized announcement panel.
